(19) United States
(12) Patent Application Publication
(10) Pub. No.: US 2011/0282589 A1
(43) Pub. Date: Nov. 17, 2011

(54) METHOD OF MEASURING PHYSICAL-CHEMICAL PARAMETERS OF NATURAL GAS

(76) Inventor: Sergey Ermishin, Sharapovskaya (RU)

(21) Appl. No.: 12/501,271

(22) Filed: Jul. 10, 2009

(51) Int. Cl. G06F 19/00

(52) U.S. Cl. 702/24

(57) ABSTRACT

The invention relates to a method for measuring physical-chemical parameters of natural gas. The pressure and the temperature of the natural gas are measured. The value of a control parameter is determined when said control parameter is used. The physical-chemical parameters corresponding to the parameters of the natural gas are selected. The data on the physical-chemical parameters of the natural gas is transmitted to a data output device.

### CROSS-REFERENCE TO RELATED APPLICATION

This application claims the benefit of the priority filing date in PCT/IB2007/003684 referenced in WIPO Publication WO/2008/084295. The earliest priority date claimed is Jan. 10, 2007.

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### FEDERALLY SPONSORED RESEARCH

None

### SEQUENCE LISTING OR PROGRAM

None

### BACKGROUND

The invention relates to the detection of natural gas by means of measurement technology, flow-through counters and measuring components which measure the flow-through, amount and calorific value of natural gas. It can be employed in particular for measuring the standard density, the carbon and nitrogen content, as well as the heating power of natural gas, of various physical-chemical compositions.

The measurements of the through-flow and the amount of natural gas, which are performed by measuring means and measuring systems having various functions, depends on the physical-chemical parameters of the natural gas (the composition of the components and the standard density), which are required for the determination of the coefficient of compression of the natural gas. In this regard, calculation methods such as NX19 Mod. and the equation of condition GERG-91 Mod. are widely employed. The measured values of density under standardized conditions ρ_{c}, the carbon dioxide content x_{y}, and the nitrogen content xₐ, can be used if the complete composition of the components of the natural gas [1-4] for calculations in accordance with this method is unknown.

Furthermore, the price of natural gas depends on its heating value, whose parameters are measured by using the highest and lowest specific combustion heat. The determination of the highest and lowest specific combustion heat is also performed on the basis of the physical-chemical measurements of the composition of the natural gas. In a case in which the complete composition of the components of natural gas is unknown, the calculation methods for the highest and lowest specific combustion heat, which can be employed on the basis of known physical-chemical parameters (xₐ, x_{y}) wherein xₐ, x_{y} are molar fractions of carbon dioxide and nitrogen in the natural gas, are determined in [5] in particular.

In a case in which the composition of the components of the gas is unknown, it is permissible to determine the highest H_{C.B.} and the lowest H_{C.H.} specific combustion heat in accordance with the equations (1):

H_{CB}=92.819(0.51447ρ_{c}+0.05603−0.65689xₐ−x_{y}),

H_{CH}=85.453(0.52190ρ_{c}+0.04242−0.65197xₐ−x_{y}) (1).

At present, the physical-chemical measurements of the density under standardized conditions ρ_{c}, of the carbon dioxide content x_{y} and of the nitrogen content xₐ are, as a rule, performed by means of measuring means such as chromatographs (fluid and laboratory chromatographs). Chromatographs are among the most expensive measuring means required for observing strict requirements made on location and for removing a specimen from natural gas. Furthermore, special laboratory conditions are required for the laboratory chromatograph. For this reason in particular, and in cases involving sufficiently large gas measuring objects for the determination of natural gas, direct measurements ρ_{c}, xₐ, x_{y} are, as a rule, only performed with the aid of expensive fluid chromatographs. This causes an additional detection error regarding ρ_{c}, xₐ, x_{y} in connection with gas measuring objectives in which the measurements are not performed with the aid of ρ_{c}, xₐ, x_{y} because of changes in the physical-chemical properties of the natural gas overtime.

The method for determining the characteristic values of physical natural gas properties is known (Russian Federation Patent No. 2269113, Application No. 2004118739/28 of Jun. 21, 2004). In the course of executing this patent, the natural gas parameters are changed by means of flow control. The pressure is measured prior to, after and during the flow control. Following the measurement of the values of said parameters, the characteristic values of the physical properties are determined in that the calculations are performed with the aid of a computer device.

The disadvantage of this method lies in the requirement in having to install turbulent and laminar flow control devices, the inability to measure chemical parameters of natural gas (carbon dioxide and nitrogen content), and large additional errors because of the necessity of having to strictly maintain the gas supply method.

From SU 702267, it is known how to determine physical-chemical parameters, in particular a coefficient of compressibility, also called a super compressibility factor, of the natural gas. This is done by measuring the total pressure and temperature prior to and following the establishment of standard conditions by throttling to ambient, or respectively normal pressure, as well as heating to 15 to 20° C.

From U.S. Pat. No. 4,584,868 it is known how to determine a coefficient of compressibility, also called a super compressibility factor, of natural gas under operating conditions by using measurement values of temperature, pressure and volume of flow under operating conditions, as well as under a pressure corresponding to standard conditions, wherein the super compressibility factor is known.

It is known from EP 0 608 736 A2 how to determine a flow volume of a pipeline gas flow under standard conditions by measuring a flow volume under operating conditions of the pipeline and by determining a volumetric correction factor. The volumetric correction factor is determined by measuring a comparison flow volume in a comparison gas flow diverted from the gas flow, measuring of an energy flow of the comparison gas flow, measuring of a heating value of the comparison gas flow, and measuring density under standard conditions. Density under standard conditions is determined by matching a pipeline gas flow measured by means of a pipeline flow volume measuring device on the basis of the volumetric correction factor. In this case, during the measurement of the comparison flow volume, the temperature of the comparison gas flow must correspond to the temperature of the pipeline gas flow.

Starting from the above state of the art, the object of the invention is based on creating possibilities for determining required physical-chemical parameters of unknown component compositions of natural gas on the basis of different components. Easily measurable macroscopic values, in particular pressure and temperature of the natural gas, are used for this.

The aim, to whose attainment the present invention is directed, is the possibility of determining the incomplete composition of the components of natural gas (density under standardized conditions, carbon dioxide and nitrogen content) by employing measurement values of the absolute pressure and temperature of the natural gas.

### RELATED LITERATURE

1. GOST 30319.2-9 Erdgas, “Die Methoden zur Berechnung der physischen Eigenschaften. Die Ermittlung des Kompressions—koeffizienten” [Methods for Calculating the Physical Properties, Determination of the Coefficient of Compressibility],

2. M. Jaeschke, A. E. Humphreys “Standard GERG Virial Equation for Field Use, Simplification of the Input Data Requirements for the GERG Virial Equation, an Alternative Means of Compressibility Factor Calculation for Natural Gases and Similar Mixtures”, GERG TM5, 1991, GERG Technical Monograph, 1991, p. 173,

3. ICO/TC 193 SC1'63, “Natural Gas—Calculation of Compression Factors, Part 3—Calculation Using Measured Physical Properties”.

4. VDI/VDE 2040, part 2, 1987. “Calculation Principles for Measurement of Fluid Flow, using Orifice Plates, Nozzles and Venturi Tubes. Equations and formulas.

5. GOST 30319.1-96 Erdgas. “Die Methoden der Berechnung der physischen Eigenschaften des Erdgases, seiner Komponenten und der Produkte seiner Verarbeitung” [Natural Gas. Methods of Calculating the Physical Properties of Natural Gas, its Components and the Products of its Processing].

### SUMMARY

The invention is based on creating possibilities for determining required physical-chemical parameters of unknown component compositions of natural gas on the basis of different components. Easily measurable macroscopic values, in particular pressure and temperature of the natural gas, are used for this.

The aim of the invention is to determine the incomplete composition of the components of natural gas (density under standardized conditions, carbon dioxide and nitrogen content) by employing measurement values of the absolute pressure and temperature of the natural gas.

The pressure and the temperature of the natural gas are measured. The value of a control parameter is determined when said control parameter is used. The physical-chemical parameters corresponding to the parameters of the natural gas are selected. The data on the physical-chemical parameters of the natural gas is transmitted to a data output device.

In particular, the invention is a method for determining at least one physical-chemical parameter of natural gas in a gas line under operating conditions, characterized by the steps of (a) measuring the pressure and temperature of natural gas under operating conditions; (b) selecting starting values from ranges defined by the quality of the natural gas and characteristic values of the detecting unit and/or a gas line; (c) calculating at least one first physical-chemical parameter by means of the pressure and temperature measured in step a) and of the starting values selected in step b); and (d) by meeting the first minimal criteria for the first wanted physical-chemical parameter.

### FIGURES

FIG. 1 is a calculation sheet of the special projection program is represented which is used for the projection of the detection units on the basis of the mass flow-through counters

FIG. 2 is the result of the calculation of the absolute value of the difference between the nominal density under standardized conditions for the selection step of the operational density 0.1 kg/m3.

FIG. 3 represents the result of the calculation of the absolute value of the difference between the compressibility factor under standardized conditions for data of the specified data fields of the density of the gas under standardized conditions pc, of the density of the gas under operating conditions ρ, of the carbon dioxide and nitrogen content of the natural gas, and the compressibility factor under standardized conditions, calculated in accordance with the calculated values of the density of the gas under standardized conditions

FIG. 4 is a graph that shows the position of the minimum of the difference between the specified and the calculated density under standardized conditions for the read-out interval of the operating density 0.01 kg/m3.

FIG. 5 represents the connection diagram of the exemplary embodiment of the method to be applied for.

### DESCRIPTION

The technical result achieved when utilizing the invention is the simplification and reduction of the outlay for the measurement method of the standard density, and the carbon dioxide and nitrogen content of natural gas.

Said technical result is obtained in that:

a) first the pressure and temperature of the natural gas is measured;

b) starting values are subsequently selected, namely from areas of the desired physical-chemical parameters, which are determined by the quality of the delivered natural gas and the characteristic values of the detection unit and/or the gas line, or respectively provided by or known from them;

c) the value of at least a first physical-chemical parameter is calculated based on the starting values of the physical-chemical parameters determined in step b) and on the pressure and temperature measured in step a); wherein the value of at least a first physical-chemical parameter is determined by meeting at least one of first minimal criterion or minimal criteria.

Expressed another way, first the absolute pressure and temperature of natural gas in the gas line is measured under operating conditions. Thereafter, knowing the quality of the natural gas being transported through the gas line, which is approximately known, for example, by spot check-like laboratory tests, or from the gas field from which the natural gas comes, the following can be determined: the range of change of the values of the density under standardized conditions of the natural gas, the range of change of the values of the content of carbon dioxide in the natural gas, the range of change of the content of nitrogen in the natural gas, and the size of the change of the values of the operating conditions. Data fields of these values, or respectively ranges of change, can be stored in a data memory. In the data memory, the data fields of the values of the density of the natural gas under operating conditions are formed by means of the minimal step in the range of the change of the density of the natural gas under operating conditions. Also, the data fields of the obtained values of the natural gas under standardized conditions are also formed in the data memory by means of the minimal step of the amount of change in the values of the density of the natural gas under standardized conditions. In addition, the data fields of the values of the content of carbon dioxide in the natural gas are formed in the data memory device by means of the minimal step in the range of the change of the values of the content of carbon dioxide in the natural gas. Also, the data fields of the values of the nitrogen content in the natural gas are formed in the data memory device by means of the minimal step in the size of the change of the nitrogen content in the natural gas. Then, for each statement of the contents of carbon dioxide and nitrogen in the natural gas under standardized conditions, for the contents of carbon dioxide and nitrogen of the natural gas, and for the measured values of absolute pressure and temperature, the data field is calculated by using the method of calculation when the complete component content of the natural gas is unknown. Subsequently the value of at least one first physical-chemical parameter is calculated on the basis of the starting values of the physical-chemical parameters which had been determined, or respectively restricted, as described above, and of the measured pressure and temperature under operating conditions. For meeting at least one first minimal criterion, or respectively minimal criteria, the calculated value of the first sought-after physical-chemical parameter, also called control parameter, is calculated for each information from the data fields of the values of the compressibility factor K, i.e., for each information from the data fields of the values of the density p of the gas under operating conditions, for each information from the data fields of the values of the density ρ_{c} of the gas under the standardized conditions, for the measured values of the absolute pressure p and the temperature T of the gas. Subsequently, the calculated value of the control parameter and the value of the control parameter from the specified information are calculated, and the information from the data fields is selected from the values of density under standardized conditions of the natural gas, from the carbon dioxide content and the nitrogen content of the natural gas, which correspond to the minimal difference between the calculated value of the control parameter, and from the value of the control parameter from the specified information. The physical-chemical parameters obtained in this way in the form of data can be transferred to the device for the issue of information. This includes selected information from the data fields of the values of the density under standardized conditions of the natural gas, the carbon dioxide content, and the nitrogen content of the natural gas (which include the minimal difference between the calculated value of the control parameter and the value of the control parameter) It is then possible to calculate the compressibility factor of the natural gas by means of a method for calculating the compressibility factor in connection with the unknown complete component content of the natural gas and, if necessary, transfer it to the device for the issue of information.

Furthermore, in a special case of working the invention, the method is characterized in that the first sought-after physical-chemical parameter is newly selected at least once, and the selection process for determining at least one sought-after physical-chemical parameter is repeated.

Moreover, in a special case of working the invention, the method is also characterized in that the first sought-after physical-chemical parameter is the gas density under standardized conditions.

Furthermore, in a special case of working the invention, the method is also characterized in that the first sought-after physical-chemical parameter is the gas density under operating conditions.

Furthermore, in a special case of working the invention, the method is also characterized in that the first minimal criteria are the minimum difference between the calculated value of the first physical-chemical parameter and its starting value.

Moreover, in a special case of working the invention, the method is also characterized in that the first sought-after physical-chemical parameter is simultaneously the first calculated physical-chemical parameter.

Furthermore, in a special case of working the invention, the method is also characterized in that the first minimal criteria are the minimum difference between the calculated value of the first physical-chemical parameter and its measured value.

Moreover, in a special case of working the invention, the method is also characterized in that steps a) to d) of searching for the unknown place values of the sought-after physical-chemical parameter are performed sequentially.

Furthermore, in a special case of working the invention, the method is also characterized in that the starting values determined in step b) are corrected during repeated temperature and pressure measurements of the natural gas, while taking into consideration the sought-after physical-chemical parameters determined in previous measurements.

Moreover, in a special case of working the invention, the method is also characterized in that the following steps are performed:

a) determination of the operating conditions of the natural gas by pressure and temperature measurements;

b) fixing the ranges on the basis of data regarding the quality of the delivered natural gas and the characteristic values of the detection unit and/or the gas line, within which the respective physical-chemical parameters of the delivered natural gas of
carbon dioxide content
nitrogen content
density under operating conditions
standard density, are located,

c) selection of the starting values for the physical-chemical parameters of
carbon dioxide content
nitrogen content
density under operating conditions
standard density,

In this case, the standard values lie below the ranges fixed in step b),

d) calculation of the coefficients of compressibility of the natural gas by means of the measured pressure and temperature, as well as by means of the starting values of the physical-chemical parameters,

e) determination of the standard density of the natural gas by means of the starting value of the density under operating conditions, the measured pressure and temperature, as well as by means of the calculated coefficient of compressibility,

f) determination of the minimal difference between the standard density calculated in the fifth step and the starting value of the standard density calculated in the third step, preferably by repeating steps c), d) and e). In this case the standard density, which is a minimal difference, is considered to be the standard density of the delivered natural gas,

g) determination of the carbon dioxide and nitrogen content corresponding to the minimal difference of the standard density.

Furthermore, in a special case of working the invention, the method is also characterized in that steps a) to f) are performed sequentially in order to find the unknown place values of the value for the standard density.

In addition, in a special case of working the invention, the method is also characterized in that following the determination of at least one sought-after physical-chemical parameter by means of meeting at least the minimal criteria, the value of at least the next sought-after physical-chemical parameter of natural gas is determined by meeting the next minimal criteria.

Moreover, in a special case of working the invention, the method is characterized in that the coefficient of compressibility of the natural gas is selected as the first sought-after physical-chemical parameter of the natural gas.

Furthermore, in a special case of working the invention, the method is characterized in that:

a) in the first step, the standard density of the natural gas is determined on the basis of the operating conditions determined on the basis of temperature and pressure measurements of the delivered gas, as well as the ranges fixed for the physical-chemical parameters, which are determined from information regarding the quality of the delivered natural gas and regarding the characteristics of the detection unit, namely
carbon dioxide content
nitrogen content
density under operating conditions
standard density.

It is furthermore possible to also determine the carbon dioxide and nitrogen content in the first step.

b) first, the coefficient of compressibility is calculated on the basis of the starting values for physical-chemical parameters lying within the fixed ranges,

c) thereafter, the calculated standard density is determined from the starting values of the density under operating conditions and from the calculated coefficient of compressibility,

d) the first step is terminated with meeting the first minimal criteria,

e) the minimal difference between the calculated standard density and the starting value of the standard density constitutes the minimal criteria,

f) in the second step, the carbon dioxide content of the delivered natural gas is determined. It is furthermore possible to determine the nitrogen content of the natural gas in the first step.

g) in the process, in the first step, on the basis of the standard values for the physical-chemical parameters of the carbon dioxide and nitrogen content in the delivered natural gas lying within the fixed ranges, the first compressibility factor under standardized conditions is calculated for the standard density determined

h) then, the second compressibility factor under standardized conditions is calculated for the standard density determined in the first step, including the difference when the first minimal criteria are met,

i) the second step is terminated when the second minimal criteria are met,

j) in this process, the difference between the first and the third coefficient of compressibility is minimal,

k) in the third step the nitrogen content of the delivered natural gas is determined,

l) in the process, the second coefficient of compressibility is calculated by means of the measured temperature and pressure, as well as of the determined values for standard density and density under operating conditions,

m) the third coefficient of compressibility is calculated by means of the starting value for the last physical-chemical parameter of the nitrogen content in the delivered natural gas, of the standard density, the density under operating conditions, and of the carbon dioxide content. Here, the starting value lies within the fixed range for nitrogen content,

n) the third step is terminated with meeting the third minimal criteria, for which the difference between the fourth and fifth coefficient of compressibility is minimal.

In practical use, when selecting the measuring means for flow-through and the amount of natural gas, the information used is that regarding the range of change of the physical-chemical parameters of the natural gas to be expected (standard density of the natural gas ρc^{min} and ρc^{max}, range of change of the carbon dioxide content xy^{min}, xy^{max}, and nitrogen content xo^{min}, xo^{max}) and the range of change of the pressure p^{min}, p^{max} and of the temperature T^{min}, T^{max} to be expected at the detection unit. As a rule, this information is sufficient for determining the range of change of the natural gas density to be expected under operating conditions at the detection unit

ρₘᵢₙ=ρc^{min}ρₘᵢₙTc/pcT^{max}K^{max}) (1)

ρ^{max}=ρc^{max}ρₘₐₓTc/pcT^{min}K^{min}) (2)

wherein K^{max} and K^{min} are the maximum and minimum values of the coefficient of compression of the natural gas at the detection unit.

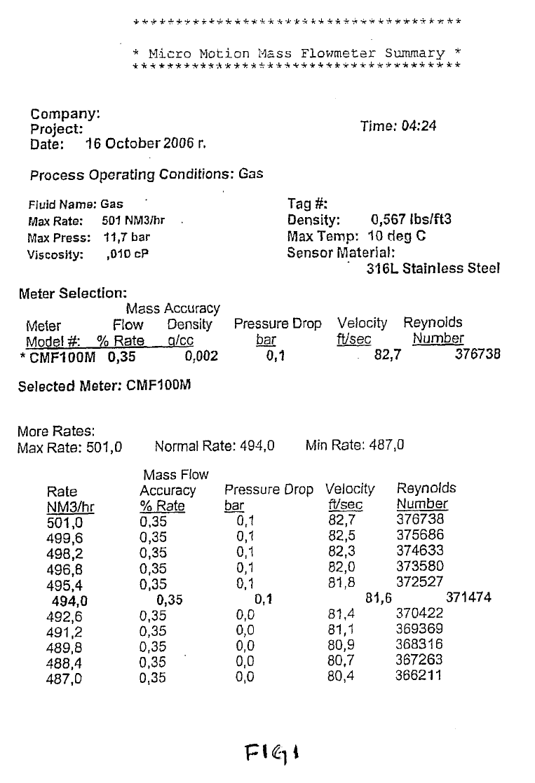

Besides, when projecting the detection units of natural gas with different ways of operating, the special program complexes for the projection (for example, for the detection units on the basis of the standardized compression devices, the program flow-through counter-ST, certified in the Russian Federation) are used, which calculate the operational density of the natural gas in the course of the projection. A calculation sheet of the special projection program is represented in FIG. 1, which is used for the projection of the detection units on the basis of the mass flow-through counters. The calculated characteristic numbers of the operating density of the natural gas at the detection unit can be viewed in this sheet, It is thus possible to specify for a detection unit of the natural gas a range of change of the base parameters which determine the equation of condition of the natural gas, taking into considerations the coefficient of compressibility, which is calculated in accordance with the incomplete component composition.

A main idea of the method to be applied for comprises the possibility of modern computers used in the detection units for the natural gas to permit the following:

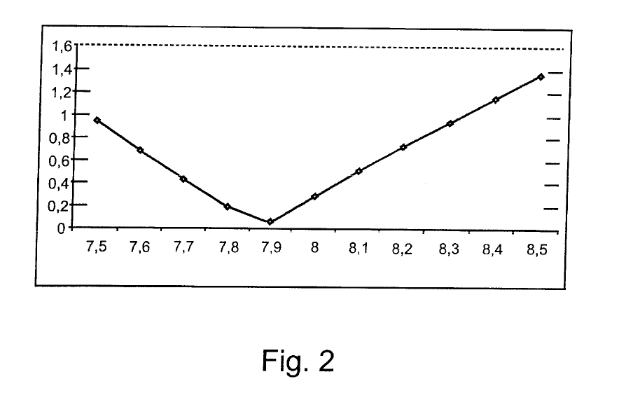

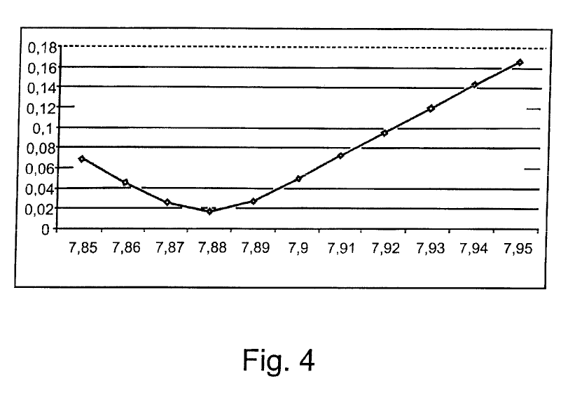

1. The range of change of the sought-after physical-chemical parameters of standard density, and carbon dioxide and nitrogen content, is known from the known quality of the delivered natural gas. Thus, those ranges can be cited or taken from the data bank, etc., within which the sought after physical-chemical parameters are located. By measuring the operating conditions of temperature and pressure it is possible to specify the range of change for the density under operating conditions. Thus, the next range can be specified, within which the fourth sought-after physical-chemical parameter is located. Six physical-chemical parameters, of which only two parameters are exactly known, determine the equation of condition of the natural gas. 2. The remaining four parameters can be calculated with the aid of modern computers by measuring only the pressure and temperature on the basis of fixed ranges within which the physical-chemical parameters are located. This takes place by means of a skilled selection of the so-called control parameter from the still known, but required physical-chemical parameters. By means of the minimal criteria, it is possible to determine the first parameter, and if required an additional control parameter, merely by measurements of temperature and pressure, by means of sorting, or in the course of the first step. This is achieved by the convergence and reproducibility of the calculated and specified values of the control parameter, for example, standard density and compressibility factor under standardized conditions. In this connection the position of the minimal criteria does not depend on the step of the selection of the control parameter, for example, the standard density (see FIGS. 2, 4). It is possible on this basis to determine the values for standard density, for the density under operating conditions, and for the carbon dioxide and nitrogen content of natural gas. In this regard, it is furthermore possible with the aid of measured pressure and temperature values of the physical-chemical parameters to employ the data banks which had been previously established by means of skilled selection of the control parameter(s).

3. The first linkage to an appropriate range of the starting values can be easily achieved by a comparison analysis of the results of the determination of, for example, the standard density, by means of the method in accordance with the invention and any arbitrary method of chemical analysis (for example pycnometric analysis). Furthermore, the capability of modern computers makes it possible to assure the convergence/reproducibility of the sequential results of the determination of the standard density, which slowly changes over time, by means of the method in accordance with the invention within the required range of the standard density.

The selection of the control parameter is determined in accordance with the requirement of the existence of the extremity of the function for the difference of the calculated and the nominal values of a control parameter (the so-called object of the static equilibrium). In this case the properties of the solution are not dependent on the dimensions of the solution. If a number of the object parameters (in particular the density under operating conditions) is not measured, the possibility arises of obtaining the solution regarding the determination of the density of the carbon dioxide and nitrogen contents under standardized conditions only. Such a control parameter is, for example, the density under standardized conditions. In this case, the position of the minimal value is not a function of the concrete values selected from the fixed range of starting values, the physical-chemical parameters, and the measuring range of temperature and pressure. Thus, the value of the standard density, independent of making available the information regarding all parameters of the gas equation of condition (with the density under operating conditions, as well as the carbon dioxide and nitrogen contents, unknown), becomes the solution of the object of the static equilibrium, which is independent of the initial dimensions. In FIG. 2, the result of the calculation of the absolute value of the difference between the nominal density under standardized conditions for the selection step of the operational density 0.1 kg/m3. This density is calculated by means of the equation of condition of the natural gas

ρ_{c}=ρ·p_{c}·T·K/(p·T_{c}) (3)

with p_{c} and T_{c} the absolute pressure and temperature under standardized conditions,
p_{c}=nominal pressure under standardized conditions,
ρ=nominal pressure under operating conditions,
K=the coefficient of compressibility of the gas, calculated in accordance with the incomplete component composition (in accordance with the specified carbon dioxide and nitrogen content and the density under standardized conditions),
p=the measured absolute pressure,
T=the measured temperature of the gas.

As can be seen from the graph in FIG. 2, the distinctive minimum difference between the calculated and nominal value of the control parameter (density under standardized conditions) exists there, i.e. the object of the search by means of the state equation of the density under standardized conditions is the assignment of the static equilibrium. In this case, the character of the position of the minimum does not depend on the specification of the read-out parameters. It defines the value of the density under standardized conditions of the natural gas independent of providing information regarding all parameters of the equation of condition of the gas (with unknown density under operating conditions and the carbon dioxide and nitrogen content).

For searching the unknown parameters of the state equation of the natural gas, it is possible to offer control parameters of different kinds, different from the density under standardized conditions (for example the coefficient of compressibility), for which the requirement of the existence of the extremities of the function regarding the difference between the calculated and nominal values of the control parameter is also met, i.e. in which the object of the search for the unknown parameters of the equation of condition of the natural gas is added to the object of the static equilibrium. The only criterion which must be met by the control parameters is the existence of the extremity of their functions. This is required for meeting the minimal criteria for the difference between the calculated and nominal value of the control parameter. These control parameters correspond to the object of the static equilibrium in the course of the determination of, or the search for, unknown physical-chemical parameters of the equation of condition of the natural gas.

It is moreover possible in connection with the search for the unknown parameters of the equation of condition of the natural gas to combine the use of control parameters of different types, i.e. to introduce the additional control parameters which permit the search for the other unknown parameters for assigning the static equilibrium, for example, the carbon dioxide and nitrogen content of the natural gas. The compressibility factor zc under standardized conditions can be such an additional control parameter

z_{c}=1−(0.0741ρ_{c}−0.006−0.063xₐ−0.0575x_{y})² (4)

with xₐ and x_{y} the molar fractions of nitrogen and carbon dioxide in the natural gas.

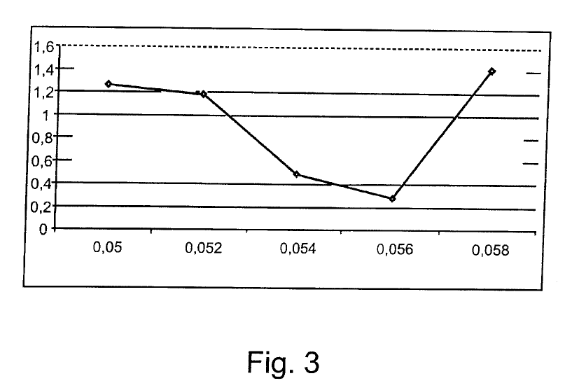

FIG. 3 represents the result of the calculation of the absolute value of the difference between the compressibility factor under standardized conditions for data of the specified data fields of the density of the gas under standardized conditions pc, of the density of the gas under operating conditions ρ, of the carbon dioxide and nitrogen content of the natural gas, and the compressibility factor under standardized conditions, calculated in accordance with the calculated values of the density of the gas under standardized conditions. The existence of the extremity of the difference between the calculated and the nominal value of the additional control parameter of the compressibility factor under standardized condition in the graph of FIG. 3 makes it possible to determine the carbon dioxide content in the natural gas in the case of the existence of the unknown parameters of the equation of condition of the natural gas (to add the object of the search for the carbon dioxide content to the object of the static equilibrium).

The parameters of the equation of condition of the natural gas which have remained unknown—the nitrogen content—are determined by searching for the minimal deviation between the coefficient of compressibility. This is calculated from the equation of condition in accordance with the equation

K=ρ_{c}·p·T_{c}/(ρ·p_{c}·T) (5)

taking into consideration the measurement information regarding the absolute pressure and temperature, and the results of the search with the aid of the control parameters for the density of gas under standardized and operating conditions, and with the aid of the method of calculating the coefficients in connection with the unknown complete component composition of the natural gas, taking into consideration the above information regarding the calculated and measured parameters. The parameters of the equation of condition of the natural gas is also determined with the aid of the control parameters of the carbon dioxide content in the gas.

Such a method for calculating the coefficient of compressibility in the case of an unknown complete component composition of natural gas is, for example, the equation of condition GERG-91 Mod. [1-3]

z=1+Bₘρ_{M}+Cₘρ²ₘ (6),

with Bₘ and Cₘ the coefficients YC,

ρₘ=molar density kmol/m^{3.}

The coefficients of the equation of condition are determined from the following equations:

Bₘ= [symbol] B₁+ [symbol] xₐB*(B₁+B₂)−1,73 [symbol] x_{y}(B₁B₃)^{0,5}++xₐ²B₂+2xₐx_{y}B₂₃+x_{y}²B₃, (7)

$${C}_{m} = {x}_{∋}^{3} {C}_{1} + 3 {x}_{∋}^{2} {x}_{a} C * {( {C}_{1}^{2} {C}_{2} )}^{1 / 3} + 2 , 76 {x}_{∋}^{2} {{x}_{y} ( {C}_{1}^{2} {C}_{3} )}^{1 / 3} ++ 3 {x}_{∋} {x}_{a}^{2} C * {( {C}_{1} {C}_{2}^{2} )}^{1 / 3} + 6 , 6 {x}_{∋} {x}_{a} {{x}_{y} ( {C}_{1} {C}_{2} {C}_{3} )}^{1 / 3} + 2 , 76 {x}_{∋} {{x}_{y}^{2} ( {C}_{1} {C}_{3}^{2} )}^{1 / 3} ++ {x}_{a}^{3} {C}_{2} + 3 {x}_{a}^{2} {x}_{y} {C}_{223} + 3 {x}_{a} {x}_{y}^{2} {C}_{233} + {x}_{y}^{3} {C}_{3} , \qquad ( 8 )$$

with x∈ the molar fraction of the equivalent hydrocarbon

[symbol]

=1−xₐ−x_{y}, (9)

$${B}_{1} = - 0 , 425468 + 2 , 865 \cdot {10}^{- 3} T - 4 , 62073 \cdot {10}^{- 6} {T}^{2} ++ ( 8 , 77118 \cdot {10}^{- 4} - 5 , 56281 \cdot {10}^{- 6} T + 8 , 8151 \cdot {10}^{- 9} {T}^{2} ) H ++ ( - 8 , 24747 \cdot {10}^{- 7} + 4 , 31436 \cdot {10}^{- 9} T - 6 , 08319 \cdot {10}^{- 12} {T}^{2} ) \times {H}^{2} , \qquad ( 10 )$$

B₂=−0,1446+7,4091·10⁻⁴T−9,1195·10⁻⁷T², (11)

B₂₃=−0,339693+1,61176·10⁻³T−2,04429·10⁻⁶T², (12)

B₃=−0,86834−4,0376·10⁻³T−5,1657·10⁻⁶T², (13)

$${C}_{1} = - 0 , 302488 + 1 , 95861 \cdot {10}^{- 3} T - 3 , 16302 \cdot {10}^{- 6} {T}^{2} ++ ( 6 , 46422 \cdot {10}^{- 4} - 4 , 22876 \cdot {10}^{- 6} T + 6 , 88157 \cdot {10}^{- 9} {T}^{2} ) H ++ ( - 3 , 32805 \cdot {10}^{- 7} + 2 , 2316 \cdot {10}^{- 9} T - 3 , 67713 \cdot {10}^{- 12} {T}^{2} ) \times {H}^{2} , \qquad ( 14 )$$

C₂=7,8498·10⁻³−3,9895·10⁻⁵T+6,1187·10⁻⁸T², (15)

C₃=2,0513·10⁻³+3,4888·10⁻⁵T−8,3703·10⁻⁸T², (16)

C₂₂₃=5,52066·10⁻³−1,68609·10⁻⁵T+1,57169·10⁻⁸T², (17)

C₂₃₃=3,58783·10⁻³+8,06674·10⁻⁶T−3,25798·10⁻⁸T², (18)

B*=0,72+1,875·10⁻⁵(320−T)², (19)

C*=0,92+0,0013(T−270). (20)

In equations (10), (14), H is calculated in accordance with the equation

H=128,64+47,479 [symbol] , (21)

in which M∈ is the molar mass of the equivalent hydrocarbon, whose value is determined from the equation

[symbol]

=(24,05525z_{c}p_{c}−28,0135xₐ−44,01x_{y})/ [symbol] . (22)

In equation (22), the molar fraction of the equivalent hydrocarbon [symbol] is calculated with the use of equation (9), and the compressibility factor under standardized conditions (zc) in accordance with the equation (4).

Following the determination of the coefficient of the state equation (6) BM, the compressibility factor at specified pressure (p, MPa) and specified temperature (T) is calculated in accordance with

z=(1+A₂+A₁/A₂)/3, (23)

with

A₂=[A₀−(A₀²−A₁³)^{0,5}]^{1/3}, (24)

A₀=1+1,5(B₀+C₀), (25)

A₁=1+B₀, (26)

B₀=bBₘ, (27)

C₀=b²Cₘ, (28)

b=10³p/(2,7715T). (29)

The coefficient of compressibility of the natural gas is calculated in accordance with equation (30)

K=z/z_{c} (30)

The method offered below is considered in accordance with the exemplary embodiment in which the density under standardized conditions pc was selected as the control parameter.

For reducing the computer outlay, it is possible to perform the read-out (sweeping) within the specified change ranges of the parameters of the density ρⁱ not at the minimum interval, but instead in steps: first in accordance with units (looking for the best solution of an accuracy of 1 kg/m³), thereafter in tens (looking for the best solution of an accuracy of 0.1 kg/m³), then in hundreds, etc. The character of the position of the minimum does not depend from the read-out interval, which in this case merely determines the accuracy of the finding of the received parameter (the density under standardized conditions). The graph in FIG. 4 shows the position of the minimum of the difference between the specified and the calculated density under standardized conditions for the read-out interval of the operating density 0.01 kg/m³. The comparison of the graphs in FIG. 2 and FIG. 4 confirms the fact of the independence of the position of the minimum of the read-out interval, which is determined by the properties of the assignment of the static equilibrium.

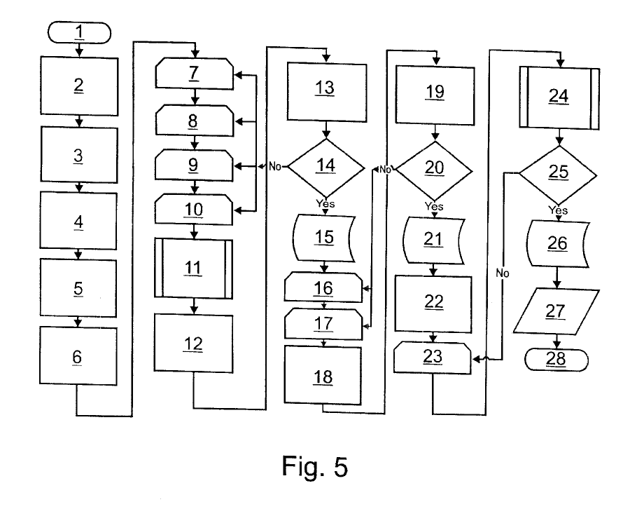

The connection diagram of the exemplary embodiment of the method to be applied for is represented in FIG. 5.

In the first step of the application of the method, the values of pressure p and temperature T at the detection unit for natural gas are measured. Furthermore, based on the project information for the detection units, the ranges of change of the density under standardized conditions p_{c}^{min}, pc^{max} are determined for the carbon dioxide content xy^{min}, xy^{max}, and nitrogen content xo^{min}, xo^{max}) in the natural gas, and for density p^{min}, p^{max} under operating conditions.

By means of registering the measured values of the pressure p and the temperature T at the detection unit for the natural gas, the complete read-out is performed within the specified ranges of change of the parameters of the density ₚⁱ under operating conditions, the density pic under standardized conditions, of the carbon dioxide content x^{k}_{y} and the nitrogen content xⁱₐ′.

For each one of the measured values of pressure p and temperature T, and each one of the read-out values of the parameters of density pi under operating conditions, the density pⁱ_{c} under standardized conditions, the carbon dioxide content x_{y}^{k} and the nitrogen content xⁱₐ′, the compressibility factor is calculated by means of the calculation method of the compressibility coefficient K^{ijkl} in the case of unknown complete component composition of natural gas, for example, the state equation GERG-91 (the expression 6, 4, 30). In the next step, the calculated density under standardized conditions \tilde{ρ}_{c}^{ijkl} is calculated by using the equation of condition of natural gas (the equation (3)) with measured values of pressure p and temperature T for each value of the compressibility coefficient K^{ijkl} and of the values of the parameters to be read out. Thereafter, a search for the minimum of the parameters is performed (FIGS. 2, 4)

Δρ_{c}^{ijkl}=|ρ_{c}^{ijkl}−\tilde{ρ}_{c}|→min (31)

The standard density specified in the current step, which is determined by the minimum of equation (31) p^{o}_{c}′ is the density under standardized conditions of the natural gas which was to be found and is determined from the equation of condition by means of introducing the equation for adding the static equilibrium.

In the next step the determination of the carbon dioxide content of natural gas is performed. To this end, the values of the parameters of nitrogen content xⁱₐ and carbon dioxide content xⁱ_{y} are read out. The compressibility factor (4) under standardized conditions z is calculated for the detected standard density p⁰_{c} of the natural gas

z_{c}(ρ_{c}⁰)^{ij}=1−(0,0741 ρ_{c}⁰−0,006−0,063xₐ¹−0,0575x_{y}^{j})² (32)

and for the calculated standard density of natural gas, taking into consideration the respective deviation

z_{c}(ρ_{c}^{o}+Δρ)^{ij}=1−(0,074(ρ_{c}⁰+Δρ)−0,006−0,063xₐⁱ−0,0575x_{y}^{j})² (33)

with xₐ and x_{y} the molar fractions of nitrogen and carbon dioxide in the natural gas.

In the next step of the algorithm, a search for the minimal value of the difference (FIG. 3) is performed

Δz^{ij}=|z_{c}(ρ_{c}⁰)^{ij}−z_{c}(ρ_{c}⁰+Δρ)^{ij}|→min (34)

The value of the molar fraction of carbon dioxide x^{o}_{y} corresponding to the minimum of the equation (34) is the value of carbon dioxide in the natural gas which had been sought and is determined from the equation for calculating the compressibility factor by means of applying the equation for the addition of the static equilibrium.

In the next step, the determination of nitrogen content in the natural gas is performed. To this end, the compressibility coefficient in accordance with the equation (5) for the found standard density of the natural gas p^{o}_{c} is calculated at the start

K=ρ_{c}⁰·p·T_{c}/(ρ·p_{c}·T) (35)

The read-out (sweeping) of the values of the parameters of nitrogen content xⁱₐ and the calculation of the compressibility factor Kⁱ is performed in the case of unknown complete component composition of natural gas, for example, with the use of the equation of condition GERG-91 (the expression 6, 4, 30) by means of the previously determined value of the molar equation of carbon dioxide x^{o}_{y} and the standard density of natural gas p^{o}_{c}. The search for the minimal value of the difference

ΔKᵢ=|K−Kⁱ|=min (36)

permits the determination of the value of the molar fraction of the nitrogen x^{o}ₐ′ which is the value of the nitrogen content in the natural gas, which was sought. The values of the density under standardized conditions poc, of the molar fractions of the carbon dioxide xoy and of the nitrogen x^{o}ₐ determined in the course of the calculations, are transferred to the device for data output.

Based on the given physical-chemical parameters, the calculation of the compressibility coefficients is performed, when required, in accordance with the equation (35) and the density under operating conditions

ρ=ρ_{c}·p·T_{c}/(p_{c}·T·K). (37)

A preferred embodiment variation of the method for determining the physical-chemical properties of the natural gas to be applied for, in particular the standard density, the density under operating conditions, the carbon dioxide and nitrogen content, provides the following: from the operating conditions determined by measuring the pressure and temperature of natural gas and from the ranges of the physical-chemical parameters fixed on the basis of information regarding the quality of the delivered natural gas, the
carbon dioxide content
nitrogen content
density under operating conditions and
standard density,
   the density of the natural gas under standardized conditions is determined in the first step with the original greater read-out interval of the operating density (for example 1 kg/m³) and of the standard density (for example 0.1 kg/m³). In the first step, the starting values of the physical-chemical parameters lying within the fixed range are initially selected. The coefficient of compressibility is then calculated from these parameters. The calculation takes place, for example, by means of the known calculation method GERG-91 for the coefficient of compressibility in the case of an incomplete component composition of natural gas. The calculated standard density is furthermore determined. The calculation of the standard density takes place on the basis of the starting values for density under operating conditions and on the basis of the calculated coefficient of compressibility with the use of the equation of condition (3) of natural gas.

The first step ends with the meeting of the first minimal criteria. The minimal difference between the calculated standard density and the starting value of the standard density can be the first minimal criteria. Here, the desired standard density of the delivered natural gas of fixed accuracy is that standard density for which the first minimal criteria have been met, in which the current read-out interval which determines the accuracy of the calculations is taken into consideration. Thereafter, the original read-out interval of the operating density (for example up to 0.1 kg/m³) and of the standard density (for example up to 0.01 kg/m³) is decreased, and the calculations are repeated until the minimal criteria are met. Thereafter, the original read-out interval of the operating density (for example up to 0.01 kg/m³) and of the standard density (for example up to 0.001 kg/m³) is again decreased, and the calculations are repeated for the third time until the minimal criteria are met. The sequential reduction of the read-out interval of the operating density is employed for making the required physical-chemical parameter more precise. Indeed, the position of the minimal criteria for the specified fixed range of the initial density under standardized conditions is unequivocal. Besides the density, it is possible in the course of these steps to derive the values for the carbon dioxide and nitrogen contents which correspond to the minimal difference of the standard density. In this case, the starting values of the ranges for the physical-chemical parameters can be corrected in the course of repeated calculations of the first and next steps by means of other pressure and temperature values of the natural gas, determined in later steps, by means of converting the values of standard density and of the carbon oxide and nitrogen content fixed during the original calculations in the first step.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method for determining at least one physical-chemical parameter of natural gas in a gas line under operating conditions, characterized by the following steps:
a) measuring pressure and temperature of natural gas under operating conditions;
b) selection of starting values from ranges defined by the quality of the natural gas and characteristic values of the detecting unit and/or a gas line;
c) calculation of at least one first physical-chemical parameter by means of the pressure and temperature measured in step a) and of the starting values selected in step b);
d) by meeting the first minimal criteria for the first wanted physical-chemical parameter.

2. The method in accordance with claim 1, characterized in that the first wanted physical-chemical parameter is newly selected at least once, and the selection process for the determination of the at least one wanted physical-chemical parameter of the natural gas is repeated.

3. The method in accordance with claim 2, characterized in that the first wanted physical-chemical parameter is the standard density of the natural gas.

4. The method in accordance with claim 2, characterized in that the first wanted physical-chemical parameter is the density of the natural gas under operating conditions.

5. The method in accordance with claim 1, characterized in that the first of the minimal criteria is the minimal difference between the calculated value of the first physical-chemical parameter and its starting value.

6. The method in accordance with claim 5, characterized in that the wanted physical-chemical parameter is also the first calculated physical-chemical parameter.

7. The method in accordance with claim 1, characterized in that the first of the minimal criteria is the minimal difference between the calculated value of the first physical-chemical parameter and its measured value.

8. The method in accordance with claim 1, characterized in that the steps a) to d) for searching for the unknown place value of the wanted physical-chemical parameter are performed sequentially.

9. The method in accordance with claim 1, characterized in that the starting values determined in the course of step b) are corrected during the repetition of the pressure and temperature measurements of the natural gas, taking into consideration the wanted physical-chemical parameters determined by means of the original measurements.

10. The method in accordance with claim 1, characterized by the following steps:
a) determination of the operating conditions of the natural gas by measuring pressure and temperature,
b) determination of ranges within which the respective physical-chemical parameters of
carbon dioxide content,
nitrogen content
density under operating conditions and
standard density
of the delivered natural gas are located,
c) selection of standard values of the physical-chemical parameters
carbon dioxide content,
nitrogen content,
density under operating conditions and
standard density,
wherein the starting values are located within the ranges determined in step b),
d) calculation of a coefficient of compressibility of the natural gas on the basis of the measured pressure and temperature, as well as on the basis of the starting values of the physical-chemical parameters,
e) calculation of the standard density by means of the starting values of the density at operating conditions, the measured pressure and temperature, and the calculated coefficient of compressibility,
f) determination of a minimal difference between the standard density calculated in step e) and the starting value of the standard density determined in step c), preferably by means of the repetition of steps c), d) and e), wherein that standard density, which has a minimal difference, is considered to be the standard density of the delivered natural gas, or respectively meets minimal criteria,
g) determination of the carbon dioxide and nitrogen contents which correspond to a minimal difference of the standard density.

11. The method in accordance with claim 10, characterized in that the steps a) to f) are sequentially performed in order to find the unknown place values of the wanted standard density.

12. The method in accordance with claim 11, characterized in that, following the determination of at least one wanted physical-chemical parameter, the value of at least one second control parameter, which is at least one next wanted physical-chemical parameter of the natural gas, is determined by meeting the next one of the minimal criteria.

13. The method in accordance with claim 12, characterized in that the compressibility factor under standardized conditions is selected as the next wanted physical-chemical parameter of the natural gas.

14. The method in accordance with claim 1, characterized in that, the coefficient of compressibility is selected as the first wanted physical-chemical parameter of the natural gas.

15. A method for the determination of physical-chemical properties of the delivered natural gas, in particular the standard density, the density under operating conditions, the carbon dioxide content, and the nitrogen content, characterized in that
a) based on operating conditions determined by measuring the pressure and temperature of the natural gas, as well as of fixed ranges of the physical-chemical parameters
carbon dioxide content,
nitrogen content,
density under operating conditions
standard density,
which are derived from information regarding the quality of the delivered natural gas and the characteristic values of the detection units, the density or the carbon dioxide content or the nitrogen content of the natural gas is determined under standardized conditions,
b) subsequently, a coefficient of compressibility is calculated from the starting values of the physical-chemical parameters lying within the fixed ranges of the starting values,
c) then, the calculated standard density is determined from the starting value of the density under operating conditions and the calculated coefficient of compressibility,
d) the first step is terminated by meeting a first one of the minimal criteria,
e) the minimal difference between the calculated standard density and the starting value of the standard density is the first of the minimal criteria,
f) in a second step the carbon dioxide content or the nitrogen content of the natural gas is determined,
g) then, the first compressibility factor under standard conditions is initially calculated for the standard density determined in the first step from the starting values for the physical-chemical parameters of the carbon dioxide and nitrogen contents of the natural gas under standardized conditions,
h) subsequently the second compressibility factor under standardized conditions is calculated for the standard density determined in the second step, including the difference after meeting the first of the minimal criteria,
i) the second step is terminated by meeting the second one of the minimal criteria,
j) in this process the difference between the second and third coefficient of compressibility is minimal,
k) in a third step the nitrogen content of the delivered natural gas is determined,
l) wherein first the second coefficient of compressibility is calculated by means of the measured pressure and temperature, as well as the determined standard density and density under operating conditions under operating conditions,
m) the third coefficient of compressibility is calculated from the starting value, located within the fixed range of the nitrogen content, for the last physical-chemical parameter of the nitrogen content of the delivered natural gas, the measured pressure and temperature, the determined standard density, the density under operating conditions and the carbon dioxide content,
n) the third step is terminated by meeting the third of the minimal criteria, for which the difference between the fourth and the fifth coefficient of compressibility is minimal.
